(19) United States
(12) Patent Application Publication
(10) Pub. No.: US 2002/0063639 A1
(43) Pub. Date: May 30, 2002

(54) Assistant system for safe driving by informative supervision and training

(76) Inventor: Katsuya Matsunaga, Chikushino-shi (JP)

Correspondence Address: Katsuya Matsunaga, 2-6-12 Musashigaoka, Chikushino-shi, Fukuoka, JP

(21) Appl. No.: 09/864,530

(22) Filed: May 22, 2001

(30) Foreign Application Priority Data
Nov. 29, 2000 (JP) 2000-403626

(51) Int. Cl. G08G 1/01

(52) U.S. Cl. 340/933; 340/436; 340/435

(57) ABSTRACT

It is reported that more than half a million souls are lost per year due to traffic accidents throughout the world. These losses have been a very serious topic. Until now, no one could understand or supervise a driver's driving behavior, unless a supervisor was with him in the same vehicle. By the use of recent computer and communication technologies, we invented a system based on our safe driving theory, for a supervisor from a remote place to supervise and train drivers to drive safely. A computer in a vehicle obtains information concerning the driver's driving behavior by sensors in the vehicle and sends it to a supervisor outside of the vehicle. The supervisor can recognize unsafe behavior and train the driver in safe driving.

### BACKGROUND OF THE INVENTION

This invention relates to a system for a supervisor from a remote place, to supervise and train drivers to drive safely.

It is reported that more than half a million souls are lost per year due to traffic accidents throughout the world. These losses have been a very serious topic. One of the goals of Intelligent Transport Systems (ITSs) is to reduce traffic accidents and enhance safety. AHSs (Advanced Cruise-Assist Highway Systems/Automated Highway Systems) will be a key technology for safe driving in ITSs. However, AHS requires many kinds of road-side infrastructures for monitoring road conditions (such as other vehicles, obstacles, road surface conditions and vehicle position), controlling the vehicle based on road conditions, and road-to-vehicle communications. Moreover, even if there are plenty of technologies for safe driving, they cannot prevent traffic accidents as long as a driver does not understand what safe driving is exactly. If the driver knew how to drive safely, warning systems or collision avoidance systems would be more effective to prevent traffic accidents. Thus we continue to study safe driving at ITSs from an educational viewpoint.

Accidents in factories that were more frequent in the past are reduced by supervision and training before they happen. In the same way, traffic accidents of commercial vehicles such as buses, trucks and taxis might be reduced by supervision and training on the spot before they happen. However, until now, no one has understood or supervised a driver's driving behavior unless a supervisor was with him in the same vehicle. In factories, a supervisor can observe workers directly and find safety problems, while traffic accidents causes are rarely revealed after the incidents.

### SUMMARY OF THE INVENTION

By the use of recent computer and communication technologies and based on our safe driving theory, we invented a system for a supervisor from a remote place, to supervise and train drivers to drive safely. A computer in the vehicle obtains information concerning the driver's driving behavior by sensors in the vehicle and sends it to the supervisor. The supervisor can recognize the driving behavior and train the driver in safe driving.

### BRIEF DESCRIPTION OF THE DRAWINGS

FIG. 1 is a block diagram of the system.

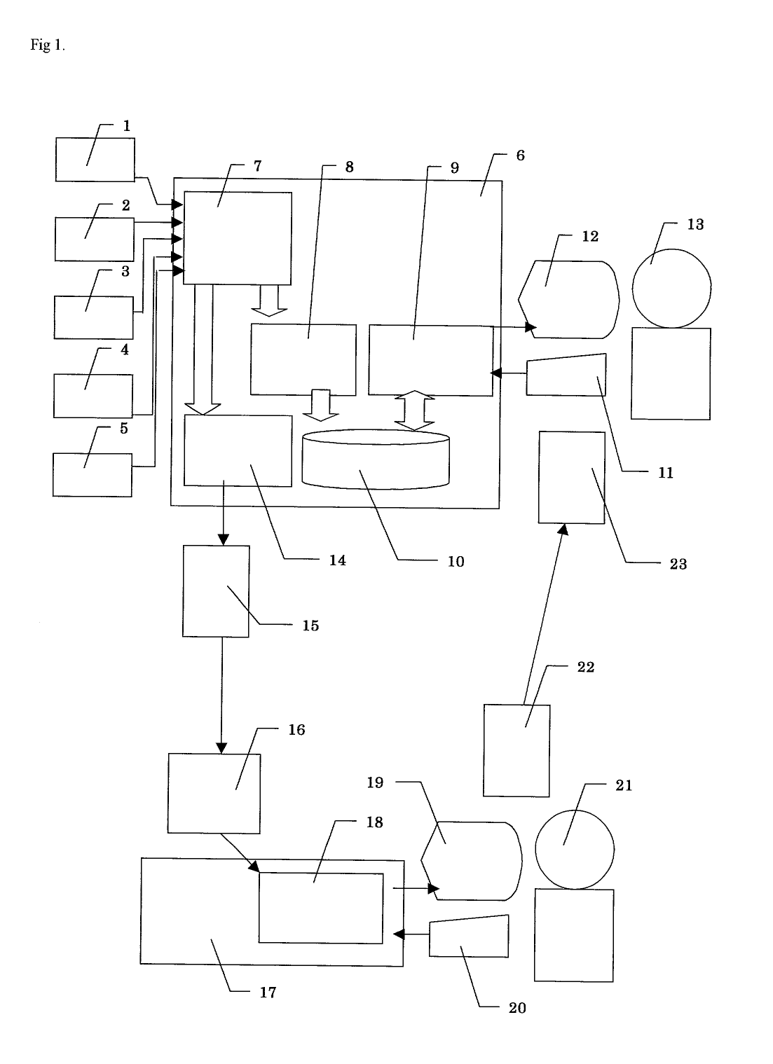

1. A speed sensor

2. A GPS

3. A laser distance measuring tool

4. A CCD camera

5. Sensors to estimate a stopping distance

6. A computer

7. A measuring program

8. A recording program

9. A management program

10. A storage device

11. An input device

12. A Display

13. A driver

14. A judgment program

15. A communication unit

16. A communication unit

17. A computer

18. A management program

19. A display

20. An input device

21. A supervisor

22. A telephone

23. A mobile phone

### DETAILED DESCRIPTION OF THE INVENTION

One of the purposes of the invention is for a supervisor to identify when a driver passes without stopping at a crossroad where the driver should stop. A computer in the vehicle gets the position by a GPS and uses a database of the crossroad in order to find whether the driver stopped or not at the crossroad. If the driver does not stop, the computer sends the information to a computer monitored by the supervisor. The computer shows the information to the supervisor who advises or warns the driver.

At the same time, the computer in the vehicle acquires an image of the front view at the crossroad and also sends it to the supervisor's computer. The supervisor can understand the situation and advise or warn the driver more precisely.

This invention, which makes it possible for a supervisor to advise and warn a driver in real time, can decrease the number of traffic accidents.

In addition to the above-mentioned facilities, the computer records driving behaviors such as speed, position, following distance as digital data.

When the following distance becomes shorter than the stopping distance, the computer warns the driver or the supervisor in order to keep sufficient following distance. By this method, a criterion of the enough following distance becomes less vague than other methods.

A traffic accident occurs when a vehicle's stopping distance is greater than the following distance from the vehicle to other vehicles or obstacles. Therefore, the following distance should be long enough to avoid a collision. However, it is difficult for a driver to estimate the stopping distance and the following distance.

Thus measurement of the stopping distance and the following distance is especially important for safe driving. The computer measures and records the stopping distance, the following distance, the speed, the position, and a front view image as digital data that is easy to reference.

In addition to measuring and recording, the computer in the vehicle sends the data to the supervisor's computer when it finds nonstop passing at a crossroad or insufficient following distance. The supervisor's computer displays the data visually for the supervisor and he can advise or warn the driver immediately.

The stopping distance is a sum of a breaking distance and a thinking distance.

The breaking distance is calculated from speed, weight, and a friction coefficient of the road.

The reaction distance is calculated from a driver's reaction time and car speed.

The following distance is measured by a laser distance measuring tool. The position is measured by a GPS. The front view image is acquired by a CCD camera.

FIGURE one is the embodying the invention. A speed sensor, a GPS, a laser distance measuring tool, a CCD camera, sensors for calculating stopping distance are connected to a computer in which a measuring program measures driving behavior consisting of speed, position, following distance, image, and data for a stopping distance.

The sensors for calculating stopping distance consist of a measuring tool for reaction time and a microphone to get sound which comes from the friction between the tires and the road, and by which this friction is estimated.

A recording program records the driving behavior on a storage device. After driving, according to a request from a driver by an input device to find nonstop passing at a crossroad or insufficient following distance, the management program shows the position and data with a video image on a display.

For supervision from a remote place in real time, a data communication unit is connected to the computer.

The judgment program checks the driving behavior to judge dangerous driving automatically. If it detects dangerous driving, it sends this information to a supervisor through the communication unit in the vehicle and the communication unit used by the supervisor. The computer receives the driving behavior from the communication unit. A management program in the computer shows the driving behavior to the supervisor on a display. The supervisor operates the computer by an input device and if the supervisor thinks the driving behavior is not safe, he/she advises the driver by telephone to a mobile phone in the vehicle.

Advantages of the invention are the capability to calculate the possibility of collision by using data about speed, following distance, and estimated stopping distance and to acquire an actual road situation that is necessary for management of safe driving. It is easy to reference, because it stores data in digital form. It can be used for both management in real time and management after driving. It is effective to educate drivers, because a supervisor can give individual advice for safe driving in real time.

What is claimed is;

1. In order to maintain safe driving, a system that measures and records the position and speed of a vehicle and sends data about driving behavior to a supervisor at a remote place automatically if a driver does not stop at a crossroad where he/she should stop.

2. In order to maintain safe driving, A system that measures following distance and position of a vehicle and sends the driving behavior to a supervisor at a remote place automatically if the following distance is less than a criterion.

3. A system claimed in claim 1 that sends a front view image from a camera in the vehicle to a remote place, if the driver does not stop at a crossroad where a driver should stop.

4. A system claimed in claim 2 that sends a front view image from a camera in the vehicle to a remote place, if the following distance is less than a criterion.

5. A system claimed in claim 2 that estimates a stopping distance of the vehicle and if the following distance is less than the stopping distance, it notifies the driver or the supervisor.
